(19) United States
(12) Patent Application Publication
(10) Pub. No.: US 2026/0233369 A1
(43) Pub. Date: Aug. 13, 2026

(54) TORQUE WRENCH

(71) Applicant: Stanley Black & Decker MEA FZE, Dubai (AE)

(72) Inventors: Ko Han Chen, Taichung (TW); Chia Cheng Chen, Taichung City (TW); Yi Tung Chan, Taichung City (TW)

(21) Appl. No.: 19/048,511

(22) Filed: Feb. 7, 2025

(51) Int. Cl. B25B 23/142

(52) U.S. Cl. CPC B25B 23/1427; B25B 23/1425

(57) ABSTRACT

A torque wrench includes a handle, a center shaft, and an output shaft assembly including an output shaft partially disposed within the center shaft. The output shaft is coupled to the center shaft such that movement of the output shaft causes movement of the center shaft. The torque wrench also includes a retainer including at least one roller, and a ring disposed at least partly around the retainer, the ring engaging with the at least one roller and rotatable relative to the retainer. The torque wrench also includes a knob that is operable between a first knob position and a second knob position and rotatably coupled to the handle. The knob is rotatable to adjust a torque setting value of the torque wrench by varying a compression of the at least one roller against the guide by the ring.

### TECHNICAL FIELD

The present disclosure relates generally to a torque wrench, and particularly to an electromechanical torque wrench.

### BACKGROUND

A conventional torque wrench applies a torque setting value to an object of the wrench (e.g., a component to be tightened). The torque setting value may be based on a torque setting set by a user. The torque wrench can be locked at the torque setting such that the torque wrench is configured to apply the torque setting value. Further, the torque setting value may not change during use of the torque wrench. However, the torque wrench may be unable to attain various torque setting values due to limitations on how the torque wrench is locked at the torque setting. For example, where the torque setting is relatively precise, the torque wrench may be incapable of attaining a similar level of precision.

### SUMMARY

In various embodiments, a torque wrench is provided. The torque wrench includes a handle, a center shaft including a center shaft interior portion disposed within the handle, and an output shaft assembly including an output shaft having an output shaft interior portion disposed within the center shaft. The output shaft is coupled to the center shaft such that movement of the output shaft causes movement of the center shaft. The torque wrench also includes a retainer including at least one roller and a ring disposed at least partly around the retainer, the ring engaging with the at least one roller and rotatable relative to the retainer. The torque wrench also includes a knob coupled to the ring and rotatable relative to the center shaft. The knob is operable between a first knob position and a second knob position and rotatably coupled to the handle. The knob is rotatable to adjust a torque setting value of the torque wrench by varying a compression of the at least one roller against the guide by the ring.

In various embodiments, a torque wrench is provided that includes a casing and a center shaft, with a portion of the center shaft disposed within the casing. The torque wrench also includes a guide coupled to the center shaft such that movement of the center shaft causes movement of the guide, a retainer disposed at least partly around the guide, the retainer including at least one roller, and a ring engaging with the at least one roller and rotatable relative to the retainer. The torque wrench also includes a knob coupled to the ring such that movement of the knob causes movement of the ring. The knob is operable between a first knob position and a second knob position. The knob contacts the casing in the first knob position and is separated from the casing in the second knob position. The ring compresses the at least one roller against the guide to resist movement of the ring relative to the guide in the first knob position. The knob is rotatable to adjust a torque setting value of the torque wrench by varying a compression of the at least one roller against the guide by the ring.

In various embodiments, a method for operating a torque wrench is provided. The torque wrench may include at least one roller, a ring, and a knob coupled to the ring. The method may include compressing, by the knob, the ring to the at least one roller such that movement of the ring is restricted. The method may also include separating, by the knob, the ring from the at least one roller such that the knob is rotatable to adjust a torque setting value associated with the torque wrench. The method may also include locking, by the knob, the torque wrench at the torque setting value by compressing the ring to the at least one roller.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

The disclosure will become more fully understood from the following detailed description, taken in conjunction with the accompanying Figures, in which like reference numerals refer to like elements unless otherwise indicated, in which:

FIG. 1 is a top view of an example torque wrench;

FIG. 2 is an exploded view of the torque wrench shown in FIG. 1;

FIG. 3 is a cross-sectional view of the torque wrench shown in FIG. 1 in a first knob position taken along plane A-A;

FIG. 4 is a cross-sectional view of the torque wrench shown in FIG. 1 in the first knob position taken along plane B-B;

FIG. 5 is a cross-sectional view of the torque wrench shown in FIG. 1 in a second knob position taken along plane A-A;

FIG. 6 is a cross-sectional view of the torque wrench shown in FIG. 1 in the second knob position taken along plane B-B;

FIG. 7 is a perspective view of a portion of the torque wrench shown in FIG. 1;

FIG. 8 is a cross sectional view of the torque wrench shown in FIG. 1 taken along plane C-C;

FIG. 9 is a perspective view of a knob and a handle of the torque wrench shown in FIG. 1;

FIG. 10 is a perspective view of a portion of the torque wrench shown in FIG. 1 in the first knob position;

FIG. 11 is a perspective view of a portion of the torque wrench shown in FIG. 1 in the second knob position;

FIG. 12 is a view of Detail A shown in FIG. 4;

FIG. 13 is a view of Detail B shown in FIG. 6;

FIG. 14 is a view of Detail C shown in FIG. 13;

FIG. 15 is a perspective view of a portion of the torque wrench shown in FIG. 1; and

FIG. 16 depicts an example method for operating the torque wrench of FIG. 1.

It will be recognized that the Figures are schematic representations for purposes of illustration. The Figures are provided for the purpose of illustrating one or more implementations with the explicit understanding that the Figures will not be used to limit the scope or the meaning of the claims.

### DETAILED DESCRIPTION

Following below are more detailed descriptions of various concepts related to, and implementations of a torque wrench that includes a ring and a knob operable to facilitate adjustment of a torque setting of the torque wrench. The various concepts introduced above and discussed in greater detail below may be implemented in any of a number of ways, as the described concepts are not limited to any particular manner of implementation. Examples of specific implementations and applications are provided primarily for illustrative purposes.

A torque wrench uses a torque setting to determine a torque setting value desired to be applied to a component. The torque setting value may be adjustable by a user to control the torque applied (e.g., the torque setting value may be based on the component). For example, car components generally have a higher torque setting value than bicycle components. A user of the torque wrench sets the torque setting and locks the torque wrench at the torque setting, with reliance on the locked torque wrench determining the torque setting value with precision and accuracy. In some situations, however, components in a mechanism to lock the torque wrench may result in the torque setting value differing from the torque setting by an error value. This can detrimentally result in overtightening or undertightening. Further, the torque wrench may not have a desirable resolution, which causes the user to use the torque wrench at an incorrect or undesired torque setting value. The resolution refers to the torque setting adjustment capability, such as 1 Newton-meter increments, 10 Newton-meter increments, 0.1 Newton-meter increments, and so on. Often times, users desire to fine tune the resolution of the torque setting.

Conventionally, mechanisms to lock the torque setting play a role in a resolution of the torque wrench defined by a smallest increment of torque that the torque wrench can determine and apply accurately. Certain locking mechanisms may only be adjusted in increments (e.g., units) such the resolution is not at a desirable value. This results in the torque setting value having low accuracy and precision. Additionally, the torque wrench may also have an associated error value due to the low accuracy and precision, further worsening the performance of the torque wrench. As a result, users may be using torque wrenches at an imprecise torque setting value despite locking the mechanism at a specific torque setting. Use of such torque wrenches can result in damage of the component and/or a system for use by the component from over-tightening, under-tightening, and/or uneven tightening between other components.

Implementations described herein relate to a torque wrench having at least one roller, a ring, and a knob coupled to the ring. The ring is configured to compress the at least one roller to restrict (e.g., prevent) an adjustment of a torque setting. To adjust the torque setting, the ring and the knob can be separated from the roller such that the knob is rotatable to adjust the torque setting. The torque setting can be locked and a torque setting value can be determined by the torque wrench by compressing the ring to the at least one roller.

Technically and beneficially, the torque wrench described herein allows for a torque setting value with a lower error value to be determined. In a traditional torque wrench with a gear locking mechanism, teeth of a first gear interact with teeth of a second gear to set the torque setting value (e.g., a peak of a tooth of the first gear locks with a root of a tooth of the second gear). When a user locks the torque setting with the traditional torque wrench, if the teeth are not engaged at the peak and the root, the gears may shift therefore changing the torque setting value relative to the torque setting the user sets. This change in the torque setting value due to the gears relative to the torque setting set by the user is referred to as the error value. By avoiding the use of the gears as is described herein with respect to the torque wrench of the present disclosure, this problem is addressed such that the torque setting set by the user can be locked at a wider range of torque setting values thereby reducing or eliminating the error value relative to an error value associated with a conventional torque wrench. As a result, the torque setting value set by a user may be substantially the same as the torque setting value the torque wrench is locked at, corresponding to the lower error value. The configuration of the torque wrench with a locking mechanism that avoids the use of gears allows for uninterrupted rotation and locking of the knob to adjust and lock the torque setting resulting in the lower error value and higher resolution in comparison to conventional torque wrenches. Furthermore, as described herein, the torque wrench is biased to a position that does not expose internal components of the torque wrench, therefore improving a longevity and overall performance of the torque wrench. As described herein, a user of the torque wrench that does not utilize gears for locking the torque setting has a wider range of torque setting values to choose from due to the usage of the ring and roller rather than gears, which improves the performance of the torque wrench at locking at a specific torque setting and may result in a desired tightening of the component during use of the torque wrench. These and other features and benefits are described more fully herein below.

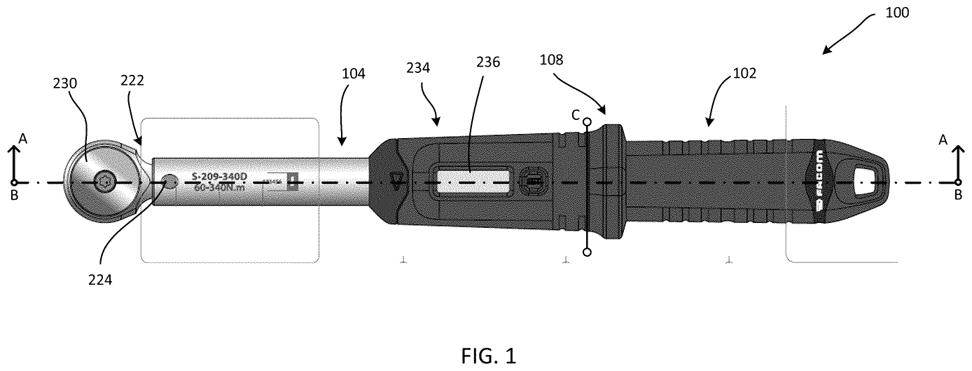

Referring now to FIG. 1, a torque wrench 100 (e.g., a mechanical torque wrench, an electromechanical torque wrench, etc.) is depicted, according to an example embodiment. The torque wrench 100 may be used to tighten a component (e.g., nut, bolt, fastener, screw, etc.) to a desired torque. This may be useful where, for example, correct installation of the component requires tightening the component to a desired torque. The desired torque for the component may, for example, be prescribed in a specification or product manual.

As is described in more detail herein, the user sets the torque wrench 100 to a torque setting associated with the desired torque. This may be done by rotation of a handle and/or a knob of the torque wrench 100, for example, as is described in more detail herein. In many instances, the torque setting may be the same as the desired torque. The torque wrench 100 determines and implements a torque setting value based on the torque setting set by the user. The torque wrench 100 includes a number of components configured to facilitate locking the torque wrench 100 at the torque setting such that adjustment of the torque setting value (e.g., accidental adjustment) is restricted.

As mentioned above, a resolution of the torque setting value refers to the precision that the torque setting value can be set to (e.g., 0.1 Nm, 0.5 Nm, etc.). The resolution of a torque wrench can be limited by the components used for locking the torque wrench at the torque setting value. For example, in some conventional torque wrenches that use gears, the gears are used to lock the torque wrench at the torque setting value. As a result, in these conventional torque wrenches, the resolution is dependent on positions in which peaks in a first gear can lock with roots in a second gear (i.e., a gear count of the gears). As such, the torque setting set by these conventional torque wrenches may differ from the torque setting value locked by the torque wrench due to shifting of the gears that may occur to lock the peaks and the roots. Thus, the precision may be limited with these conventional torque wrenches.

Unlike these conventional torque wrenches, the torque wrench 100 does not utilize gears to lock the torque wrench 100 at the torque setting value (i.e., the torque wrench 100 is ‘gear-less’). As a result of not being limited by gears in this way, the torque wrench 100 provides a greater resolution than conventional torque wrenches.

Still referring to FIG. 1, the torque wrench 100 includes a handle 102 (e.g., grip, user interface device, etc.). A user of the torque wrench 100 may engage with (e.g., grasp, etc.) the handle 102 to tighten (e.g., adjust, torque down, etc.) the component until the current torque output value of the torque wrench 100 exceeds the torque setting value of the torque wrench 100.

In various embodiments, as described herein, the torque wrench 100 includes a display (i.e., an electronic display device that may provide indications of various settings and controls, such as the torque setting value, to a user of the torque wrench). The display may be an suitable electronic display device. As indicated above, the display may display the torque setting value to the user (e.g., so that the user understands how to engage with the component). As discussed in more detail below, the handle 102 facilitates locking of the torque wrench 100 at the torque setting value (e.g., after rotation of a knob sets the torque setting value, etc.).

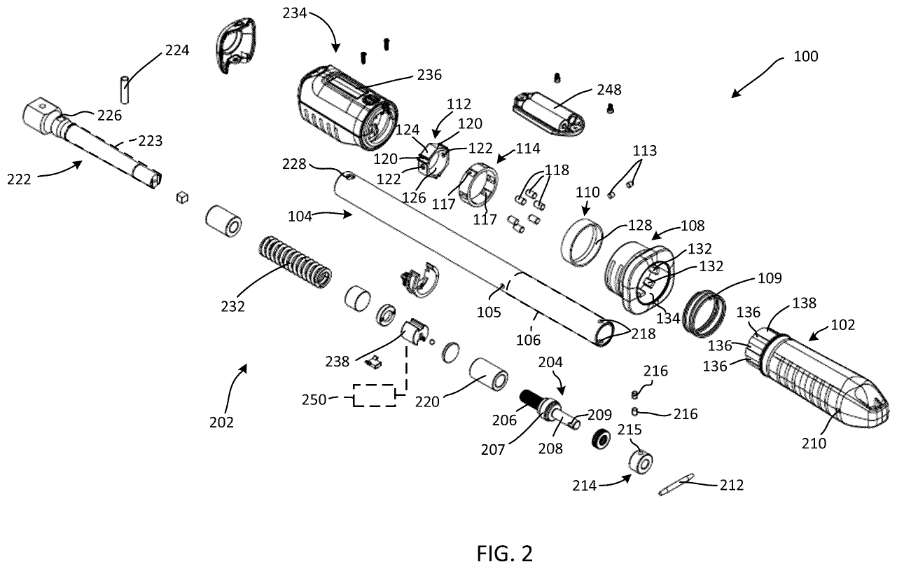

The torque wrench 100 also includes a center shaft 104 (e.g., central portion, centrally disposed member, etc.). The center shaft 104 includes a center shaft interior portion 106 that is disposed within the handle 102. The center shaft 104 may be manufactured from a metal or primarily metal-based material (e.g., steel or aluminum), in some embodiments. In various embodiments, as shown in FIGS. 1 and 2, the center shaft 104 is a tube (pipe, etc.) that defines a cavity for receiving one or more components. In the example shown, the center shaft is a straight tube (i.e., substantially not bent or curved). However, the center shaft 104 may also include a portion that is angled or curved to provide enhanced comfort and/or control during use of the torque wrench 100.

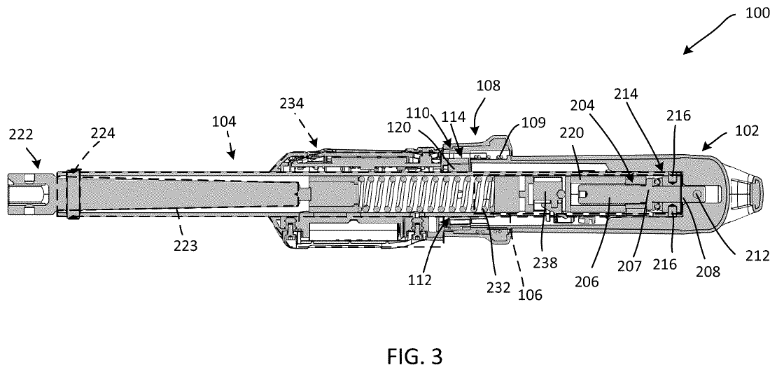

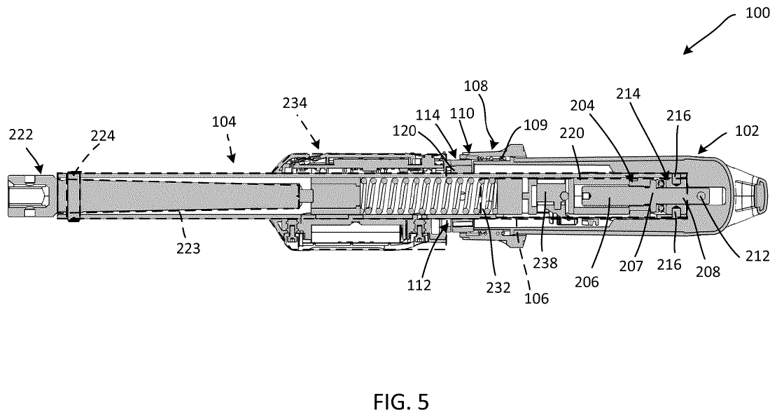

The torque wrench 100 also includes a knob 108 (e.g., collar, rotatable member or element, etc.). The knob 108 is operable between a first knob position and a second knob position. The knob 108 is rotatably coupled to the handle 102. In the first knob position, as shown in FIGS. 3, 4, and 12, among others, rotation of the knob 108 is restricted such that the handle 102 cannot rotate. As a result, the torque setting value cannot be adjusted in the first knob position. In the second knob position, as shown in FIGS. 5, 6, and 13, among others, rotation of the knob 108 is allowed and the knob 108 is configured to rotate with the handle 102. In other words, in the second knob position, the knob 108 can freely rotate and movement of the knob 108 causes movement of the handle 102. This enables adjustment of the torque setting value in the second knob position. As is explained in more detail herein, rotation of the knob adjusts a torque setting value of the torque wrench 100 by varying a compression of at least one roller against a guide by a ring. In this way, the knob 108 facilitates adjustment of the torque setting value in a gear-less manner.

As shown in FIG. 2, the knob 108 includes protrusions 132 (e.g., raised members, etc.) on a portion of an inner surface 134 of the knob 108. The handle 102 includes grooves 136 (e.g., recesses, indents, etc.) on an upper surface 138 of the handle 102 that is proximate to the knob 108 such that the protrusions 132 and the grooves 136 can interact with each other. In the example shown, a shape of the protrusions 132 and the grooves 136 complement each other such that the protrusions 132 can couple to the grooves 136. For example, as shown in FIG. 2, the protrusions 132 are rectangular and the grooves 136 are rectangular such that the protrusions 132 can fit within the grooves 136. The protrusions 132 are disposed (e.g., positioned, etc.) on a portion of the inner surface 134 away from the handle 102, such that when the knob 108 is in the first knob position and the second position, the protrusions 132 and the grooves 136 are in contact which allows the handle 102 and the knob 108 to be rotatably coupled. In the second knob position, the protrusions 132 are moved (e.g., slid, etc.) along the grooves 136 such that the knob 108 can freely rotate and therefore the handle 102 can rotate. Although protrusions 132 and inner surface 134 are used to couple the knob 108 to the handle 102 in the second knob position, other coupling mechanisms can be used such that the knob 108 is rotatably coupled to the handle 102.

In various embodiments, the torque wrench 100 also includes a knob spring 109. The knob spring 109 is disposed between the handle 102 and the knob 108. The knob spring 109 biases the knob 108 to the first knob position and resists movement of the knob 108 from the first knob position to the second knob position such that a force by a user of the torque wrench 100 is required to move the knob 108 from the first knob position to the second knob position. In this way, the knob spring 109 mitigates unintentional adjustment of the torque setting value. In various embodiments, at least a portion of the knob spring 109 is contacting the grooves 136 of the handle 102 such that the protrusions 132 is biased to not couple to the grooves 136, therefore biasing the knob 108 to the first knob position.

The torque wrench 100 also includes a ring 110 (e.g., sleeve, cylindrical or circular-shaped member, etc.). The ring 110 is coupled to the knob 108 and is circular or substantially circular-shaped. In various embodiments, as shown in FIGS. 3-6, 12, and 13, the ring 110 is disposed within, at least partly, the knob 108. For example, the ring 110 may be press fit (e.g., via an interference fit, etc.) into the knob 108. The ring 110 may have a smooth inner circumferential surface (e.g., a surface with a constant diameter, etc.). In various embodiments, the ring 110 is made from metal (e.g., aluminum, steel, etc.).

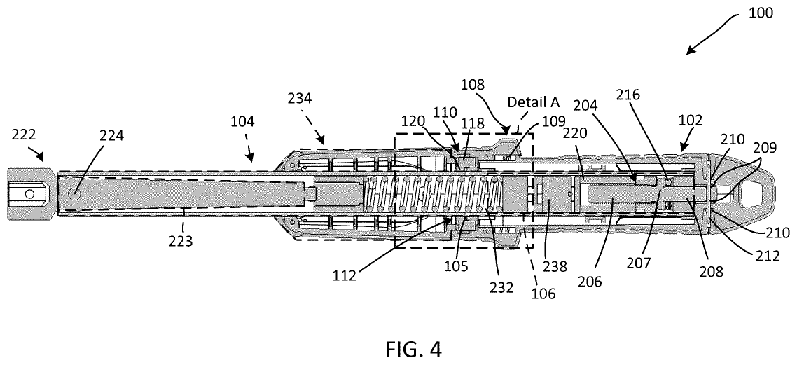

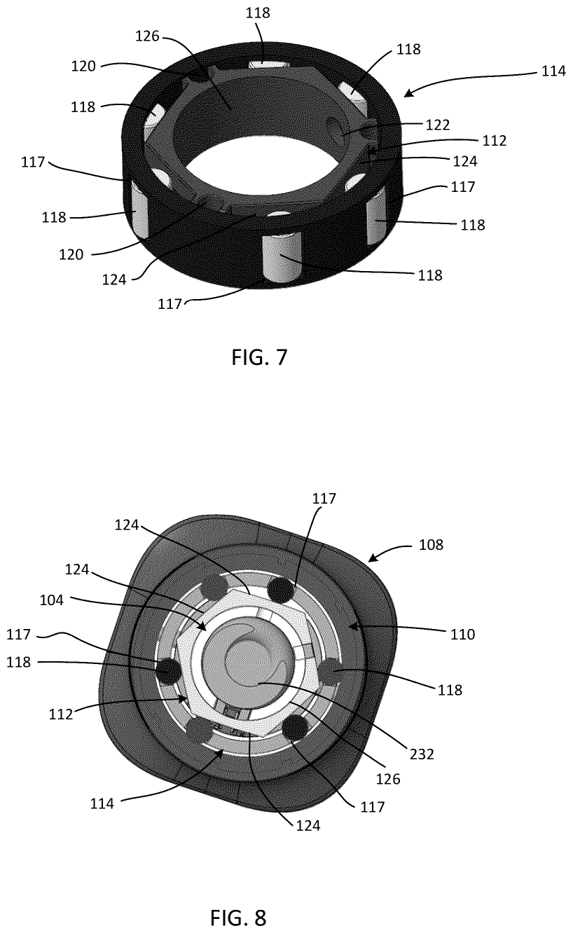

The torque wrench 100 also includes a guide 112. The guide 112 is coupled to the center shaft 104 such that movement of the guide 112 causes movement of the center shaft 104. In some embodiments, the center shaft 104 has a set of openings 105 and the guide 112 is coupled to the center shaft 104 using pins 113 extending through the openings 105 into the center shaft 104 into openings 122 of the guide 112, as shown in FIGS. 4, 6, and 15. In various embodiments, such as is shown in FIGS. 2 and 7, the guide 112 has an outer surface formed from a plurality of intersecting flat surfaces 124 (e.g., a hexagonal outer surface, etc.) and a cylindrical inner surface 126. In various embodiments, the guide 112 is made from metal.

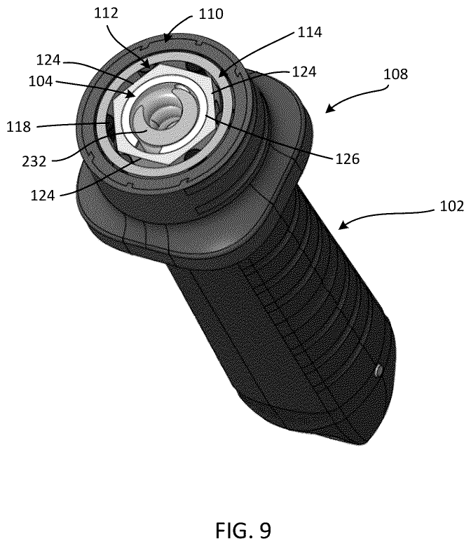

The torque wrench 100 also includes a retainer 114. The retainer 114 is disposed or positioned at least partly around the guide 112. For example, an entirety of the retainer 114 can be disposed around the guide 112 such that the retainer 114 extends around the guide 112. In other examples, as shown in FIG. 7, a first portion of the retainer 114 may not be disposed around the guide 112 such that a second portion of the retainer 114 that is not the entirety of the retainer 114 is disposed around the guide. For example, the retainer 114 may have a first length greater than a second length of the guide 112. The retainer 114 facilitates movement of the ring 110 relative to the guide 112. In various embodiments, the retainer 114 is annular or ring shaped. As shown in FIGS. 7-9, the retainer 114 has a cylindrical inner surface and a cylindrical outer surface, in various embodiments. The retainer 114 includes a plurality of apertures 117 (e.g., openings, etc.). In some embodiments, as shown in FIG. 7, the retainer 114 includes the same number of the apertures 117 as the guide 112 includes of the flat surfaces 124. Additionally, the retainer 114 may be configured such that each of the apertures 117 may be located over one of the flat surfaces 124 of the guide 112. The retainer 114 may be made from a metal or primarily metal-based material (e.g., steel), in some embodiments. In other embodiments, a different material may be utilized. In some embodiments, the guide 112 and the retainer 114 may be integrally formed. For example, a single unitary component may include a first portion functioning as the guide 112 and a second portion functioning as the retainer 114. In other embodiments, the retainer 114 and the guide 112 may be separate components that are coupled together.

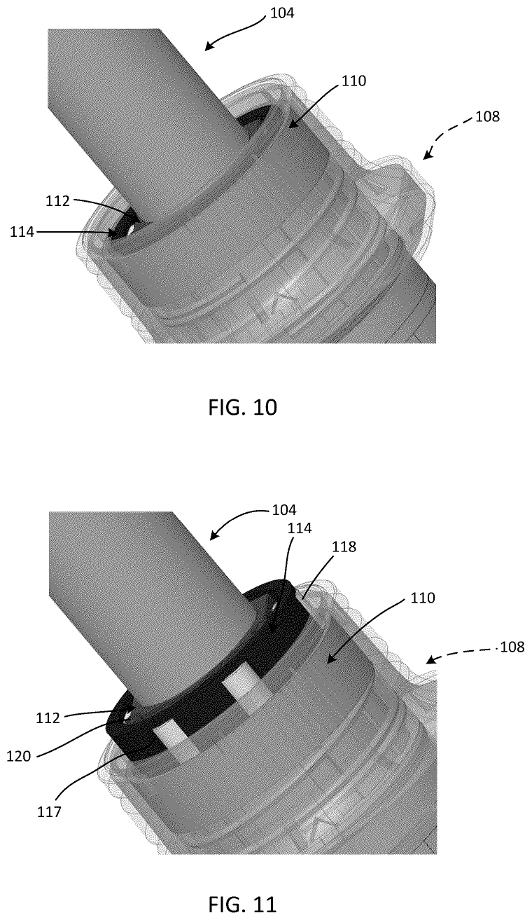

The torque wrench 100 also includes at least one roller 118 (e.g., bearing, etc.). Each of the rollers 118 is disposed in one of the apertures 117 and captured between or substantially between the guide 112 and the ring 110. In various embodiments, the torque wrench 100 includes the same number of the rollers 118 as the apertures 117 of the retainer 114. The rollers 118 are disposed within the apertures 117 such that a portion of each of the rollers 118 protrudes outwards from the retainer 114, as shown in FIGS. 4 and 6-8. As a result, the rollers 118 are configured to separate (e.g., provide a distance between) the retainer 114 from the ring 110. The ring 110 is disposed at least partly around the retainer 114. For example, as shown in FIG. 10, in the first knob position, a first portion of the ring 110 is disposed around the retainer 114. The first portion can be the entirety of the ring 110 such that the ring extends around the retainer 114. In the second knob position, as shown in FIG. 11, a second portion of the ring 110 is disposed around the retainer 114 such that at least a portion of the rollers 118 is exposed and the ring 110 is partly around the retainer 114. The first portion of the ring 110 is greater than the second portion of the ring 110 to facilitate operation of the first knob position and the second knob position, as described herein. The rollers 118 are configured to facilitate selective movement of the ring 110 relative to the guide 112. In this way, the rollers 118 facilitate operation of the knob 108 in the first knob position and the second knob position.

The ring 110 engages with the rollers 118 to facilitate movement of the knob 108 between the first knob position and the second knob position. In the first knob position, as shown in FIGS. 3, 4, and 12, the ring 110 compresses the rollers 118 against the guide 112 to resist movement of the ring 110 relative to the retainer 114 to restrict rotation of the knob 108 and the handle 102. The flat surfaces 124 of the guide 112 facilitate the compressing of the rollers 118, as shown in FIG. 8. The apertures 117 may be disposed such that at least one of the rollers 118 is compressed against the guide 112 at a portion of a corresponding one of the flat surfaces 124 where a distance between the flat surfaces 124 and the ring 110 is at a minimum.

In the second knob position, shown in FIG. 11 among others, at least a portion of the ring 110 is not compressing the rollers 118. This lack of compression facilitates rotation of the knob 108 and the handle 102. As described herein, movement of the protrusions 132 along the grooves 136 facilitates the movement of the knob 108 from the first knob position to the second knob position and the knob 108 and the handle 102 can rotate relative to the center shaft 104. As is explained in more detail below, the knob 108 is rotatably coupled to the handle 102 in the second knob position such that the lack of compression facilities rotation of the knob 108 and the handle.

The configuration of the ring 110 with the rollers 118 facilitates uninterrupted rotation of the knob 108 (and the handle 102), and therefore selection by the user of a torque setting value within a wider range of possible torque setting values than is available in conventional torque wrenches that are limited by their use of gears. The resolution of the torque wrench 100 may be significantly increased relative to conventional torque wrenches due to usage of the ring 110 and the rollers 118.

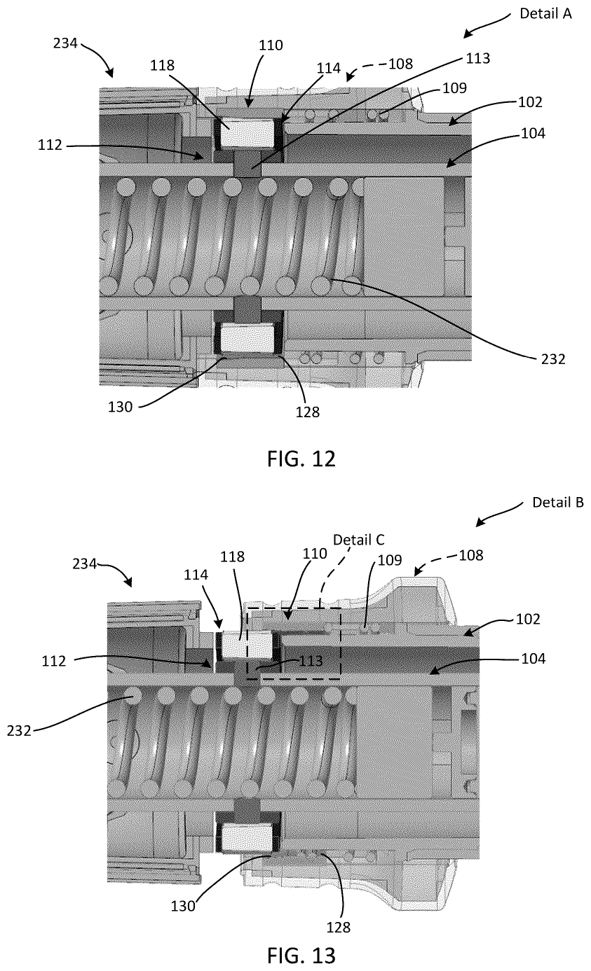

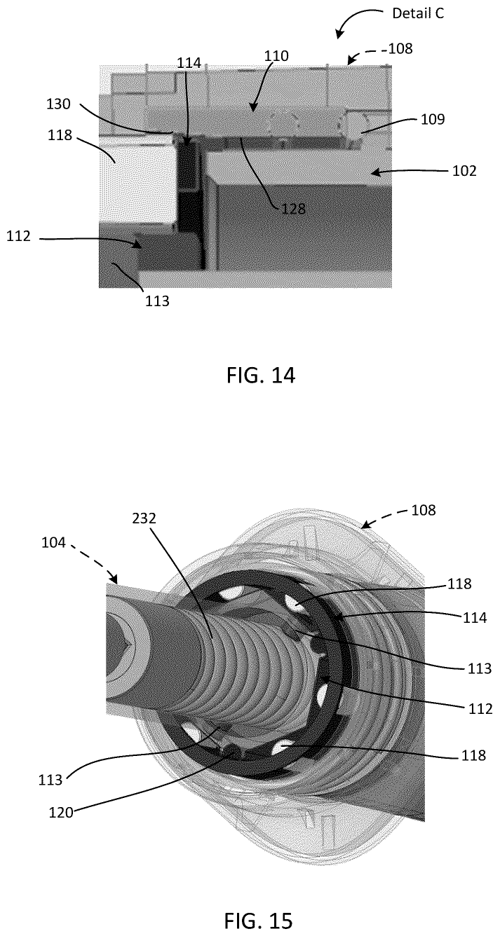

The ring 110 has an inner surface 128. The inner surface 128 is disposed over the rollers 118 and is configured to interface with the rollers 118. In various embodiments, as shown in FIGS. 12-14, the inner surface 128 includes a frustoconical portion 130. The frustoconical portion 130 extends from an edge of the ring 110 farthest from the handle 102. The frustoconical portion 130 extends along a length of the inner surface 128. In some embodiments, the frustoconical portion 130 extends along an entirety of the length of the inner surface 128.

As shown in FIGS. 12-14, the frustoconical portion 130 is in confronting relation with the rollers 118 while a lower portion of the inner surface 128 is disposed over a portion of the handle 102 in the second knob position, and this lower portion of the inner surface 128 is cylindrical. This configuration facilitates rotation of the knob 108 (and the handle 102) relative to the center shaft 104 in the second knob position while also facilitating, in the first knob position, compression of the rollers 118 against the ring 110 to restrict rotation of the ring 110 (and therefore the knob 108 (and the handle 102)) relative to the center shaft 104. In various embodiments, the rollers 118 engage the frustoconical portion 130 in the second knob position such that the rollers 118 facilitate rotation of the ring 110 relative to the center shaft 104 in the second knob position.

The guide 112 includes at least one channel 120 (e.g., tunnel, etc.). As shown in FIGS. 7 and 15, each of the channels 120 extends outward from an external surface of the guide 112. In some embodiments, each of the channels 120 extends outward from the external surface of the guide 112 between two of the rollers 118. The retainer 114 extends around each of the channels 120. Each of the channels 120 cooperates with the retainer 114 to define a tunnel (e.g., passage, etc.). The torque wrench 100 may include one or more wires (e.g., electrical wires, etc.) or other components that extend between the guide 112 and the retainer 114. In one example, at least one channel 120 may receive one or more of these components and, particularly, at least one wire. Beneficially, the tunnels (e.g., shields) facilitate routing of these wires through the torque wrench 100, and protect or shield the wires during operation of the torque wrench so that the wires are less likely to be rubbed, cut, or otherwise interacted with in an adverse way.

The torque wrench 100 also includes an output shaft assembly 202 to operate the torque wrench 100. A portion of the output shaft assembly 202 is disposed within the center shaft 104. The output shaft assembly 202 includes a coupler 204. At least a portion of the coupler 204 is disposed within the center shaft interior portion 106.

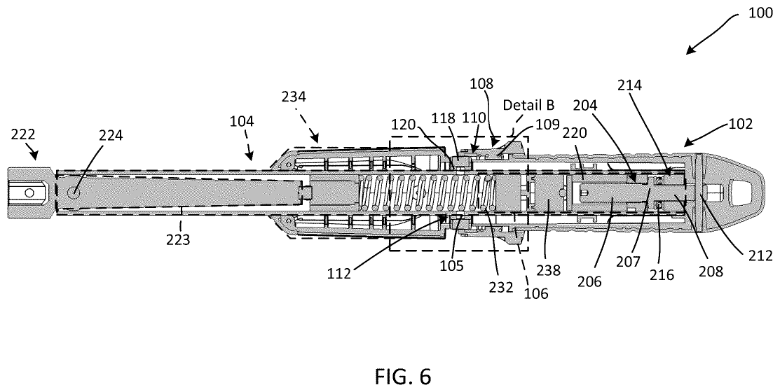

The coupler 204 includes a post 208 that is coupled to the handle 102. At least a portion of the post 208 is not disposed in the center shaft interior portion 106, as shown in FIGS. 3-6. In various embodiments, the post 208 is coupled to the handle 102 with a handle rod 212. The post 208 has two post holes 209 and the handle 102 includes two corresponding handle holes 210. The handle rod 212 passes through the post holes 209 and the handle holes 210, as shown in FIGS. 4 and 6 such that rotation of the handle 102 rotates the post 208.

The coupler 204 also includes a threaded shaft 206. The threaded shaft 206 is disposed within the center shaft interior portion 106. The threaded shaft 206 includes external threads on an exterior portion of the threaded shaft 206. As is explained in more detail herein, the threaded shaft 206 and the coupler 204 facilitate adjustment of the torque setting.

In various embodiments, as shown in FIGS. 2-6, the coupler 204 includes a flange 207. The flange 207 is disposed between the threaded shaft 206 and post 208. The flange 207 separates the threaded shaft 206 and the post 208. As is explained in more detail herein, the flange 207 presses against a spring to facilitate adjustment of the torque setting.

As shown in FIG. 2, the output shaft assembly 202 also includes an inner ring 214 that is coupled to the center shaft 104. The inner ring 214 is passed through the post 208, as shown in FIGS. 3-6. The inner ring 214 is disposed between the flange 207 and the post holes 209 (and therefore the handle rod 212). In some embodiments, the inner ring 214 is coupled to the center shaft 104 with two plugs 216. In such embodiments, the inner ring 214 has two holes 215 and the center shaft 104 has two corresponding holes 218. Each of the plugs 216 passes through one of the holes 215 and one of the holes 218, as shown in FIGS. 3 and 5. The inner ring 214 and the post 208 are configured such that the post 208 is rotatable within, and relative to, the inner ring 214.

The output shaft assembly 202 also includes a seat, particularly a threaded seat 220, that is disposed within the center shaft interior portion 106. The threaded seat 220 has a threaded opening that is threadably coupled to the threaded shaft 206, as shown in FIGS. 3-6. The threaded seat 220 has internal threads that correspond with the external threads of the threaded shaft 206. The flange 207 may have a diameter that is larger than a diameter of the threaded shaft 206 and greater than an inner diameter of the threaded seat 220 such that contact between the flange 207 and the threaded seat 220 prohibits further threading of the threaded seat 220 onto the threaded shaft 206 (and therefore limits adjustment of the torque setting).

The output shaft assembly 202 also includes an output shaft 222 that is rotatably coupled to the center shaft 104. The output shaft 222 includes an output shaft interior portion 223 that is disposed within the center shaft 104. The output shaft interior portion 223 is disposed within a center shaft exterior portion of the center shaft 104. As shown in FIGS. 3-6, the center shaft exterior portion is not disposed within the handle 102.

In various embodiments, the output shaft 222 is coupled to the center shaft 104 with a head rod 224 of the output shaft assembly 202. The output shaft 222 has an opening 226 that corresponds with an opening 228 on the center shaft 104. The head rod 224 passes through the opening 226 and the opening 228 to couple the output shaft 222 to the center shaft 104, as shown in FIG. 3.

As shown in FIG. 1, in various embodiments, the torque wrench 100 also includes a ratchet head 230. The output shaft 222 is coupled to the ratchet head 230. The ratchet head 230 may attach to a component to be fastened such that force by a user on the torque wrench 100 (e.g., on the handle 102) tightens the component. The ratchet head 230 may be a gear head, an open-end head, or another attachment configured to facilitate tightening or loosening of the component.

The output shaft assembly 202 also includes a spring 232, as shown in FIG. 2. At least a portion of the spring 232 is disposed within the center shaft interior portion 106 and the spring 232 is disposed between the output shaft interior portion 223 and the threaded seat 220. A compression of the spring 232 is adjusted dependent on the torque setting of the torque wrench 100.

Rotation of the knob 108 and the handle 102 in the second knob position causes rotation of the handle rod 212, and therefore of the post 208 and the coupler 204 relative to the center shaft 104. The rotation of the threaded shaft 206 causes movement of the threaded seat 220 relative to the coupler 204, which changes a compression of the spring 232 (e.g., increasing or decreasing compression of the spring 232). The change in compression of the spring 232 determines the torque setting value as a resistance that must be overcome for the torque wrench 100 to tighten a component such that a current torque output value reaches the torque setting value.

The spring 232 may be one factor in defining a torque range (e.g., a range of possible torque setting values, etc.) for the torque wrench 100. Stiffer springs 232 can handle higher compression, therefore having higher torque values than softer springs 232. Similarly, varying thread pitch and thread length of the threaded shaft 206 and the threaded seat 220 affects how the compression of the spring 232 changes with rotation of the handle 102. For example, finer threads on the threaded shaft 206 and the threaded seat 220 may allow for more precise adjustments to the torque setting value in comparison to coarser threads.

The adjustments of the compression of the spring 232 (e.g., with the coupler 204, the threaded shaft 206, and the threaded seat 220) from rotating the knob 108 and the handle 102 adjusts the torque setting value of the torque wrench 100. Additionally, when a force is applied on the torque wrench 100 during use, the torque wrench 100 uses a sensor (as is described in more detail below) and the spring 232 to determine when a current torque output value, which corresponds to the force applied, exceeds the torque setting value. For example, when fastening a bolt, a user can adjust the knob 108 and the handle 102 to set the torque wrench 100 to the torque setting value, couple the torque wrench 100 to the bolt, and apply force on the torque wrench 100 until the torque wrench 100 indicates (e.g., via a display, etc.) that the current torque output value exceeds the torque setting value.

Additionally, the output shaft assembly 202 may include other components (e.g., additional rings, screws, fasteners, etc.) to facilitate operation of the torque wrench 100. For example, in various embodiments, the output shaft assembly 202 may also include a bushing (e.g., washer, etc.) disposed between the flange 207 and the inner ring 214.

In various embodiments, as is shown in FIG. 1, the torque wrench 100 also includes a casing 234 disposed between the knob 108 and the output shaft 222. The torque wrench 100 also includes a power system. The power system may provide power to various components. In the example shown, the power system is a battery system 248. The battery system 248 may house one or more electrical storage devices (e.g., batteries, capacitators, etc.) that selectively provides power to one or more components (e.g., the electronic display described herein). The battery system 248 may be used to power electrical components of the torque wrench 100. The casing 234 may house a number of components of the torque wrench 100, such as the battery system 248. Additionally, the casing 234 includes a display 236. As described herein, the display 236 is used to display information, such as a torque setting value, a current torque output value, etc. The display 236 may display this information in real-time, such as while a user engages with the torque wrench 100.

The casing 234 is coupled to the center shaft 104 and the output shaft interior portion 223 such that movement of the output shaft interior portion 223 causes movement of the center shaft 104 and the casing 234. In various embodiments, as shown in FIGS. 3-6, a portion of the center shaft 104 is disposed within the casing 234. The knob 108 is disposed between the casing 234 and the handle 102. As shown in FIGS. 3, 4, and 12, in the first knob position, the knob 108 contacts the casing 234. In various embodiments, the casing 234 includes grooves and/or openings that a portion of the knob 108 fits into to allow the contacting of the knob 108 and the casing 234. In the second knob position, as shown in FIGS. 5, 6, and 13, the knob 108 is separated (e.g., distanced, etc.) from the casing 234. As discussed in more detail herein, this separation of the knob 108 from the casing 234 is large enough such that the ring 110 is not compressing the rollers 118 and rotation of the knob 108 relative to the casing 234 is facilitated in the second knob position. For example, the separation of the knob 108 from the casing 234 may be greater than a length of the rollers 118 along a longitudinal length of the torque wrench. In another example, the separation of the knob 108 from the casing 234 may be greater than half the length of the rollers 118.

The torque wrench 100 also includes at least one sensor 238. As shown in FIGS. 3-6, the sensor 238 is disposed between the spring 232 and the threaded seat 220 such that a change in compression of the spring 232 during movement of the threaded seat 220 is sensed by the sensor 238. In various embodiments, the sensor 238 is or includes at least one of load cell, a force sensor, a torque sensor, a strain gauge, or other similar sensors. For example, a load cell and a strain gauge may be used as the sensor 238 to measure force applied to the torque wrench 100 which can then be converted to torque to determine the current torque output value, for example.

The sensor 238 contacts a portion of the output shaft assembly 202 and detects changes to the compression of the spring 232 to determine the current torque output value (e.g., when a user is using the torque wrench 100 to apply torque on a component, etc.). Additionally, the sensor 238 may be used to determine the torque setting value when a user sets the torque setting value with the handle 102. In various embodiments, the torque wrench 100 includes another or a second sensor similar to the sensor 238 such that the sensor 238 is used to detect the torque setting value and the second sensor is used to detect the current torque output value applied to the torque wrench 100.

In various embodiments, the torque wrench 100 includes at least one controller including at least one processing circuit 250. The processing circuit 250 may have at least one memory device and at least one processor. In some embodiments, the processing circuit 250 may have a communications interface. The processing circuit 250 are coupled to the sensor 238 to receive inputs (e.g., signals, etc.) from the sensor 238 and perform various operations according to the inputs. For example, the processing circuit 250 may be used to receive or determine the torque setting value. The user can rotate the handle 102 to adjust the compression of the spring 232 and change the torque setting value, and the sensor 238 can use the adjustment such that the at least one processing circuit 250 can determine the torque setting value. In another example, the at least one processing circuit 250 may be used to determine a current torque output value of the torque wrench 100, which is defined as a current torque applied by the torque wrench 100 to a component, by using the sensor 238. For example, as a user applies the torque wrench 100 to the component, the sensor 238 may receive information on a change of compression of the spring 232 using the output shaft assembly 202 and this information can be received by the processing circuit 250 to determine a corresponding current torque output value associated with the change of compression of the spring 232.

In some examples, the at least one processing circuit 250 may be configured to provide an indication (e.g., an audio signal, a tactile signal, etc.) when servicing of the torque wrench 100 is necessary. For example, after a predefined duration or number of uses, the processing circuit 250 may provide an indication via the display device (e.g., “Servicing Needed”). As another example, the processing circuit 250 may provide or cause to provide an audible, visual, and/or tactile output regarding operation of the torque wrench.

The processing circuit 250 may be embodied as machine or computer-readable media storing instructions that are executable by a processor. As described herein and amongst other uses, the machine-readable media facilitates performance of certain operations to enable reception and transmission of data. For example, the machine-readable media may provide an instruction (e.g., command, etc.) to, e.g., acquire data. The computer readable media instructions may include code, which may be written in any programming language including, but not limited to, Java or the like and any conventional procedural programming languages, such as the “C” programming language or similar programming languages. The processing circuit 250 may be embodied as a hardware unit, such as one or more electronic control units. As such, the processing circuit 250 may be embodied as one or more circuitry components including, but not limited to, processing circuitry, input devices, output devices, sensors, etc.

The memory device (e.g., memory, memory unit, storage device) may include one or more devices (e.g., Flash memory) for storing data and/or computer code for completing or facilitating the various processes, layers and modules described in the present disclosure. The memory device may be communicably connected to the processor to provide computer code or instructions to the processor for executing at least some of the processes described herein. Moreover, the memory device may be or include tangible non-volatile memory. Accordingly, the memory device may include database components, object code components, or any other type of information structure for supporting the various activities and information structures described herein.

The display 236 is coupled to the at least one processing circuit 250. Information may be exchanged between the controller and the display 236, where the information may relate to one or more components of FIG. 2 or determinations, as described herein, of the controller and/or the processing circuit 250. The display 236 is configured to display information on the torque wrench 100. In various embodiments, the at least one processing circuit 250 is configured to provide a display signal to the display 236. The display signal includes information according to a state of the torque wrench 100. The display signal can cause the display 236 to depict the torque setting value, for example.

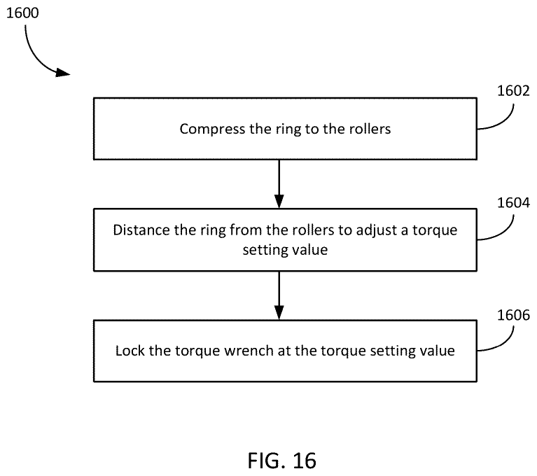

Based on the foregoing, operation of the torque wrench may now be explained. Referring to FIG. 16, a method 1600 for operating the torque wrench 100 is shown, according to an example embodiment.

The method 1600 includes compressing, by the knob 108, the rollers 118 such that movement of the ring 110 is restricted at step 1602. In various embodiments, movement of the ring 110 is prevented. In other embodiments, movement of the ring 110 within a predefined amount is permitted. The predefined amount may be less than full (e.g., substantial) movement of the ring 110. For example, the predefined amount may be less than a movement of the ring 110 that can adjust the torque setting value. At step 1602, the torque wrench 100 is in a first knob position, as described herein in reference to FIGS. 3, 4, 10, and 12. In the first knob position, although the knob 108 is rotatably coupled to the handle 102 (e.g., with the protrusions 132 and the grooves 136), rotation of the knob 108 and the handle 102 to adjust the torque setting value is restricted. For example, as described herein, the knob 108 is restricted from rotating at the first knob position, therefore restricting rotation of the handle 102 and adjustment of a torque setting value. At step 1602, the ring 110 compresses the rollers 118 to resist movement of the ring 110 relative to the retainer 114 to restrict rotation of the knob 108. In various embodiments, as shown in FIGS. 12-14, the ring 110 has a portion of the inner surface 128 that includes the frustoconical portion 130. The portion of the inner surface 128 that includes the frustoconical portion 130 is proximate the guide 112 in the second knob position. The portion of the inner surface 128 closest to the guide 112 includes the frustoconical portion 130 such that the frustoconical portion can interact with the guide 112, the retainer 114, and the rollers 118. In various embodiments, as shown in FIGS. 12 and 13, at least a portion of the frustoconical portion 130 is disposed around the guide 112 in both the first knob position and the second knob position. The frustoconical portion 130 extends along a length of the inner surface 128. In some embodiments, the frustoconical portion 130 extends along an entirety of the length of the inner surface 128.

The method 1600 also includes separating, by the knob 108 and after compressing the ring 110 to the at least one roller 118, the ring 110 from the rollers 118 such that the knob 108 is rotatable to adjust a torque setting value associated with the torque wrench 100 at step 1604. At step 1604, the torque wrench 100 is in a second knob position, as described herein in reference to FIGS. 5, 6, 11, and 13. In the second knob position, movement of the knob 108 adjusts the torque setting value. For example, the knob 108 can be configured to rotate with the handle 102 such that movement of the knob 108 causes movement of the handle 102 to adjust the torque setting value. In step 1604, the knob 108 and the handle 102 are rotatable relative to the center shaft 104 to allow adjustment of the torque setting value, as described herein in reference to the center shaft 104 and the output shaft assembly 202. The ring 110 is separated from the rollers 118 by a distance large enough such that the knob 108 can freely rotate. For example, the ring 110 can be separated from the rollers such that a first portion of the rollers 118 that the ring 110 is contacting is less than a second portion of the rollers 118 that the ring 110 is not contacting. The at least a portion of the ring 110 not compressing the rollers 118 allows for the movement of the knob 108. The configuration of the ring 110 with the rollers 118 facilitates uninterrupted rotation of the knob, and therefore selection by the user of the torque setting value within a wider range of possible torque setting values than is available in conventional torque wrenches.

The method 1600 also includes setting, by the knob 108 and after adjusting the torque setting value, the torque setting value by compressing the ring 110 to the rollers 118 at step 1606. Similar to step 1602, the torque wrench 100 is in the first knob position where the ring 110 is compressing the rollers 118 to restrict rotation of the ring 110 and the knob 108 such that the torque setting value cannot be adjusted.

In various embodiments, the knob 108 includes protrusions 132 on a portion of the inner surface 134 of the knob 108 and the handle 102 includes grooves 136 on an upper surface 138 of the handle 102 that is proximate to the knob 108 such that the protrusions 132 and the grooves 136 can interact with each other. The protrusions 132 are disposed on a portion of the inner surface 134 away from the handle 102, such that when the knob 108 is in the first knob position and the second position (e.g., steps 1602-1608), the protrusions 132 and the grooves 136 are in contact and the knob 108 is rotatably coupled to the handle 102. In step 1604, the protrusions 132 are moved (e.g., slid, etc.) along the grooves 136 and this movement facilitates the separation of the ring 110 from the rollers 118, allowing the knob 108 and the handle 102 to rotate together to adjust the torque setting value.

A description of operation may be as follows. A user may enter or provide a desired torque setting value by adjusting the knob 108 and the handle 102 in the second knob position. Advantageously, the use of the torque wrench 100 including the ring 110 and the rollers 118 facilitates continuous rotation of the knob 108 and the handle 102 to adjust the torque setting value and enables a relatively greater precision as well as amount of torque settings to be achieved compared to conventional torque wrenches. Compression of the rollers 118 to the ring 110 in the first knob position allows for locking along a relatively wider range of torque setting values in comparison to conventional torque wrenches, which may include a mechanism whereby the torque setting value is locked at preset increments resulting in a limited range of torque setting values and a relatively high error value. The torque setting value may be displayed by the display 236 such that the user knows the torque setting. The user may use the torque wrench 100 on a component (e.g., a fastener on a vehicle). A current torque output value, which corresponds to a torque value of the component may be displayed by the display 236. Then, the user may apply torque (e.g., tighten) to the component to adjust the current torque output value to the torque setting value. An output (e.g., a visual output on the display 236, an audio signal, etc.) may occur when the current torque output value reaches the torque setting value. Beneficially the torque wrench 100 as described herein with a locking mechanism that does avoids the use of gears has a relatively lower error value and may result in better performance of the torque wrench 100 when applied to the component.

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be in the scope of the appended claims.

The term “coupled” and the like, as used herein, mean the joining of two components directly or indirectly to one another. Such joining may be stationary (e.g., permanent) or moveable (e.g., removable or releasable). Such joining may be achieved with the two components, or the two components and any additional intermediate components being integrally formed as a single unitary body with one another, with the two components, or with the two components and any additional intermediate components being attached to one another.

It should be understood that the controller may include any number of circuits for completing the functions described herein. For example, the activities and functionalities of the processing circuit 250 may be combined in multiple circuits or as a single circuit. Additional circuits with additional functionality may also be included. Further, the controller may further control other activity beyond the scope of the present disclosure.

While the term “processor” is briefly defined above, the term “processor” and “processing circuit” are meant to be broadly interpreted. In this regard and as mentioned above, the “processor” may be implemented as one or more processors, application specific integrated circuits (ASICs), field programmable gate arrays (FPGAs), digital signal processors (DSPs), or other suitable electronic data processing components structured to execute instructions provided by memory. The one or more processors may take the form of a microprocessor, etc.

It is important to note that the construction and arrangement of the various systems shown in the various example implementations is illustrative only and not restrictive in character. All changes and modifications that come in the spirit and/or scope of the described implementations are desired to be protected. It should be understood that some features may not be necessary, and implementations lacking the various features may be contemplated as in the scope of the disclosure, the scope being defined by the claims that follow. When the language “a portion” is used, the item can include a portion and/or the entire item unless specifically stated to the contrary.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values (e.g., W1 to W2, etc.) herein are inclusive of their maximum values and minimum values (e.g., W1 to W2 includes W1 and includes W2, etc.), unless otherwise indicated. Furthermore, a range of values (e.g., W1 to W2, etc.) does not necessarily require the inclusion of intermediate values in the range of values (e.g., W1 to W2 can include only W1 and W2, etc.), unless otherwise indicated.

What is claimed is:

1. A torque wrench comprising:
a handle;
a center shaft comprising a center shaft interior portion disposed within the handle;
an output shaft assembly comprising an output shaft having an output shaft interior portion disposed within the center shaft, the output shaft coupled to the center shaft such that movement of the output shaft causes movement of the center shaft;
a retainer comprising at least one roller;
a ring disposed at least partly around the retainer, the ring engaging with the at least one roller and rotatable relative to the retainer; and
a knob coupled to the ring and rotatable relative to the center shaft, the knob operable between a first knob position and a second knob position and rotatably coupled to the handle to adjust a torque setting value of the torque wrench by varying a compression of the at least one roller against the guide by the ring.

2. The torque wrench of claim 1, wherein, in the second knob position, the knob is coupled to the handle such that movement of the knob causes movement of the handle.

3. The torque wrench of claim 1, further comprising a guide coupled to the center shaft between the output shaft and the handle;
wherein the retainer is disposed at least partly around the guide.

4. The torque wrench of claim 3, wherein, in the first knob position, the ring compresses the at least one roller against the guide to resist movement of the ring relative to the guide.

5. The torque wrench of claim 3, wherein:
the at least one roller comprises two rollers; and
the guide comprises a channel extending outward from an external surface of the guide between the two rollers, the channel cooperating with the retainer to define a tunnel.

6. The torque wrench of claim 3, wherein the ring has an inner surface proximate the guide, the inner surface being frustoconical shaped.

7. The torque wrench of claim 1, wherein the output shaft assembly further comprises:
a coupler comprising a threaded shaft and a post, the threaded shaft disposed within the center shaft interior portion, the post coupled to the handle;
a threaded seat disposed within the center shaft interior portion, the threaded seat comprising a threaded opening threadably coupled to the threaded shaft; and
a spring, a portion of the spring being disposed within the center shaft interior portion between the output shaft interior portion and the threaded seat and configured such that rotation of the handle in the second knob position causes rotation of the coupler relative to the center shaft, movement of the threaded seat relative to the coupler, and a change in compression of the spring.

8. The torque wrench of claim 1, further comprising a knob spring disposed between the handle and the knob, the knob spring configured to bias the knob to the first knob position and to resist movement of the knob from the first knob position to the second knob position.

9. The torque wrench of claim 1, further comprising a casing coupled to the center shaft and the output shaft interior portion such that movement of the output shaft interior portion causes movement of the center shaft and the casing, the knob disposed between the casing and the handle.

10. A torque wrench comprising:
a casing;
a center shaft, a portion of the center shaft disposed within the casing;
a guide coupled to the center shaft such that movement of the center shaft causes movement of the guide;
a retainer disposed at least partly around the guide, the retainer comprising at least one roller;
a ring engaging with the at least one roller and rotatable relative to the retainer; and
a knob coupled to the ring such that movement of the knob causes movement of the ring, the knob operable between a first knob position and a second knob position, the knob contacting the casing in the first knob position and separated from the casing in the second knob position, the knob being rotatable to adjust a torque setting value of the torque wrench by varying a compression of the at least one roller against the guide by the ring;
wherein the ring compresses the at least one roller against the guide to resist movement of the ring relative to the guide in the first knob position.

11. The torque wrench of claim 10, further comprising an output shaft assembly comprising an output shaft having an output shaft interior portion disposed within the center shaft, the output shaft coupled to the center shaft such that movement of the output shaft causes movement of the center shaft.

12. The torque wrench of claim 11, further comprising a handle, wherein the center shaft comprises a center shaft interior portion disposed within the handle.

13. The torque wrench of claim 12, wherein the output shaft assembly further comprises:
a coupler comprising a threaded shaft and a post, the threaded shaft disposed within the center shaft interior portion, and the post coupled to the handle;
a threaded seat disposed within the center shaft interior portion, the threaded seat comprising a threaded opening threadably coupled to the threaded shaft; and
a spring, a portion of the spring being disposed within the center shaft interior portion between the output shaft interior portion and the threaded seat and configured such that rotation of the handle in the second knob position causes rotation of the coupler relative to the center shaft, movement of the threaded seat relative to the coupler, and a change in compression of the spring.

14. The torque wrench of claim 12, further comprising a knob spring disposed between the handle and the knob, the knob spring configured to bias the knob to the first knob position and to resist movement of the knob from the first knob position to the second knob position.

15. The torque wrench of claim 10, wherein:
the at least one roller comprises two rollers; and
the guide comprises a channel extending outward from an external surface of the guide between the two rollers, the channel cooperating with the retainer to define a tunnel configured to receive a wire.

16. The torque wrench of claim 10, wherein the ring has an inner surface disposed proximate the guide and having a frustoconical shape.

17. A method for operating a torque wrench having at least one roller, a ring, and a knob coupled to the ring, the method comprising:
compressing, by the knob, the ring to the at least one roller such that movement of the ring is restricted;
after compressing the ring to the at least one roller, separating, by the knob, the ring from the at least one roller such that the knob is rotatable to adjust a torque setting value associated with the torque wrench; and
after adjusting the torque setting value, locking, by the knob, the torque wrench at the torque setting value by compressing the ring to the at least one roller.

18. The method of claim 17, wherein the ring has an inner surface proximate the at least one roller, the inner surface being frustoconical shaped.

19. The method of claim 17, wherein:
the torque wrench further includes a center shaft, a portion of an outer surface of the center shaft coupled to the knob;
the torque wrench further includes a handle coupled to the knob; and
the knob and the handle are rotatable relative to the center shaft when the ring is separated from the at least one roller.

20. The method of claim 17, wherein:
the torque wrench further includes a handle rotatably coupled to the knob, the handle including grooves disposed on an outer surface of the handle, the outer surface proximate to the knob;
the knob comprises protrusions on a portion of an inner surface of the knob, the protrusions coupled to the grooves to couple the handle to the knob; and
separating the ring from the at least one roller comprises moving the protrusions along the grooves such that the knob is rotatable, allowing rotation of the knob and the handle to adjust the torque setting value.
